(19) United States
(12) Patent Application Publication
(10) Pub. No.: US 2021/0406969 A1
(43) Pub. Date: Dec. 30, 2021

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Shin SAKURADA, Toyota-shi (JP); Shuichi SAWADA, Nagoya-shi (JP); Daiki YOKOYAMA, Gotemba-shi (JP); Takaharu UENO, Nagoya-shi (JP); Yurika TANAKA, Yokosuka-shi (JP); Genshi KUNO, Kasugai-shi (JP)

(73) Assignee: TOYOTA JIDOSHA KABUSHIKI KAISHA, Toyota-shi (JP)

(21) Appl. No.: 17/341,913

(22) Filed: Jun. 8, 2021

(30) Foreign Application Priority Data
Jun. 26, 2020 (JP) 2020-110814

(51) Int. Cl. G06Q 30/06; G06Q 30/02

(52) U.S. Cl. CPC G06Q 30/0601; G06Q 30/0201

(57) ABSTRACT

An information processing apparatus disclosed includes a controller configured to execute the processing of obtaining user identification information for identifying a user, obtaining property information indicating a property of the user on the basis of the user identification information, and determining an upper limit number on the basis of the property information. The upper limit number is the number of specific items that the user is allowed to purchase.

### CROSS REFERENCE TO THE RELATED APPLICATION

This application claims the benefit of Japanese Patent Application No. 2020-110814, filed on Jun. 26, 2020, which is hereby incorporated by reference herein in its entirety.

### BACKGROUND

### Technical Field

The present disclosure relates to a technology for managing sales of items.

### Description of the Related Art

There is a known sales management technology for controlling the number of items that each user is allowed to purchase at a special price at the time of checking-out (see, for example, Patent Literature 1 in the citation list below).

### CITATION LIST

### Patent Literature

Patent Literature 1: Japanese Patent Application Laid-Open No. 2010-039554

### SUMMARY

An object of this disclosure is to provide a technology that can improve the accuracy in controlling the number of items that each user is allowed to purchase.

Disclosed herein is an information processing apparatus for controlling the number of sold items. The information processing apparatus may comprise, for example, a controller which includes at least one processor,

the controller being configured to execute the processing of:

obtaining user identification information for identifying a user,

obtaining property information indicating a property of the user on the basis of the user identification information, and

determining an upper limit number on the basis of the property information, the upper limit number being the number of specific items that the user is allowed to purchase.

Also disclosed herein is an information processing method for controlling the number of sold items. The information processing method may comprise the following steps of processing executed by a computer:

obtaining user identification information for identifying a user,

obtaining property information indicating a property of the user on the basis of the user identification information, and

determining an upper limit number on the basis of the property information, the upper limit number being the number of specific items that the user is allowed to purchase.

Also disclosed herein is an information processing program for implementing the above-described information processing method and a non-transitory storage medium in which this information processing program is stored.

This disclosure provides technology that can improve the accuracy in controlling the number of items that each user is allowed to purchase.

### BRIEF DESCRIPTION OF THE DRAWINGS

FIG. 1 is a diagram illustrating an exemplary configuration of a sales management system to which the technology disclosed herein is applied.

FIG. 2 is a block diagram schematically illustrating exemplary components of the sales management system.

FIG. 3 illustrates an exemplary structure of an item information table according to an embodiment.

FIG. 4 illustrates an exemplary structure of a user information table according to the embodiment.

FIG. 5 is a flow chart of a process executed by the server apparatus according to the embodiment.

FIG. 6 illustrates an exemplary structure of a user information table according to a first modification.

FIG. 7 is a flow chart of a process executed by the server apparatus according to the first modification.

FIG. 8 illustrates an exemplary structure of a user information table according to a second modification.

### DESCRIPTION OF THE EMBODIMENTS

When a certain item is sold at a special (or bargain) price at a store or shop, they sometimes limit the number of items that each user is allowed to purchase. Likewise, when an item whose demand exceeds supply (or a scarce item) is sold, they sometimes limit the number of items that each user is allowed to purchase. This way of selling enables more users to purchase the item sold at a special price or the scarce item. Such items will also be collectively referred to as specific items hereinafter.

Even in the case where the above sales method is adopted, if a user who has already purchased a certain number of specific items comes to a place of checkout for the second (or more) time or enters the store for the second (or more) time, it is difficult for the store to check the number of specific items that the user has already purchased. In consequence, users who act in this way (namely, come to a place of checkout or enter the store more than once) can purchase a larger number of specific items than the limited number set by the store. In other words, users acting in the above way can buy an unduly large number of specific items. This may make it difficult to allow more users to purchase the specific item.

The information processing apparatus disclosed herein includes a controller configured to obtain information for identifying a user (or user identification information). An example of the aforementioned “user” is a user who wishes to purchase a specific item. As user identification information for such a user, image information of the user may be used. Image information of the user may be captured by a camera when the user addresses a salesclerk to proceed with checking-out the specific item. Other possible examples of the user identification information include identification information of electronic money used by the user, identification information of a credit card used by the user, or customer identification information allotted to the user by the seller (or the store) of the specific item.

The controller of the information processing apparatus obtains information indicating properties of the user (which will be referred to as “property information”) on the basis of the user identification information. The property information may be information about the number of specific items that the user has purchased (first information), information about the composition of the user's family (second information), or information about a record of an instance of resale conducted by the user in the past (third information). Such property information may be stored in a storage unit of the information processing apparatus in advance with the user identification information linked with it. The second information and the third information may be provided by an external service against a receipt of the user identification information.

The controller of the information processing apparatus determines the number (or the upper limit number) of specific items that the user is allowed to purchase on the basis of the property information. The “upper limit number” defined in the context of this disclosure refers to the number of specific items that the user is allowed to purchase through the present checkout process. In the case where the property information includes the first information, the controller may set the upper limit number smaller when the number of specific items that the user has purchased is large than when it is small. In the case, for example, where the number of specific items that each user is allowed to purchase in total is limited, the above feature can prevent each user from purchasing a larger number of specific items than the limited number with improved reliability. In the case where the property information includes the second information, the controller may set the upper limit number larger when the number of members of the user's family is large than when it is small. Thus, the information processing apparatus can set the number of specific items that the user is allowed to purchase to a number appropriate for the composition of the user's family. The aforementioned members of the user's family may be the members who live in the same house as the user. In the case where the property information includes the third information, the controller may set the upper limit number smaller when there is a record of an instance of resale conducted by the user in the past than when there is not. This can prevent the user from purchasing an unduly large number of specific items for the purpose of resale with improved reliability.

The information processing apparatus configured as above can control the number of specific items that each user can purchase with improved accuracy.

The controller of the information processing apparatus may determine the aforementioned upper limit number taking into account the specific items in stock in addition to the property information. In other words, the controller of the information processing apparatus may determine the upper limit number on the basis of the property information and information about the specific items in stock (which will also be referred to as “stock information” hereinafter). In doing so, for example, the controller may set the upper limit number smaller when the number of specific items in stock is small than when it is large. This allows more users to purchase the specific item when the number of specific items in stock is small.

The controller of the information processing apparatus may determine the aforementioned upper limit number taking into account the demand for the specific item in addition to the property information. In other words, the controller of the information processing apparatus may determine the upper limit number on the basis of the property information and information about the demand for the specific item (which will also be referred to as “demand information” hereinafter). In doing so, for example, the controller may set the upper limit number smaller when the demand for the specific item is high than when it is low. This allows more users to purchase the specific item for which the demand is high. In this connection, the demand for the specific item may be either the demand in the store or stores under the management of the information processing apparatus or the demand in the market.

The controller of the information processing apparatus may determine the aforementioned upper limit number taking into account the stock information about the specific item and the demand information in addition to the property information. For example, the controller may set the upper limit number smaller when the number of specific items in stock is small and the demand for the specific item is high than when the number of specific items in stock is large and the demand is low. This allows more users to purchase the specific item even when the number of specific items in stock is small and the demand is high.

The controller of the information processing apparatus may execute the processing of informing a person in charge of sales of the upper limit number determined as above. For example, the controller may send information about the determined upper limit number to a terminal used to perform the checkout process to inform the person in charge of sales of the upper limit number through this terminal. Thus, the person in charge of sales can know the upper limit number of the specific items that the user is allowed to purchase. Consequently, the person in charge of sales can take an action to prevent the number of specific items sold to the user from exceeding the upper limit number. For example, if the user wishes to purchase a larger number of specific items than the upper limit number, the person in charge of sales can ask the user to reduce the number of specific items to be purchased to or below the upper limit number.

### Embodiment

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of the disclosure only to them, unless otherwise stated.

What is described in the following as an embodiment is a system for managing sales of items in a store or a shop to which the information processing apparatus according to this disclosure is applied. This system will also be referred to as the “sales management system” hereinafter.

(Outline of Sales Management System)

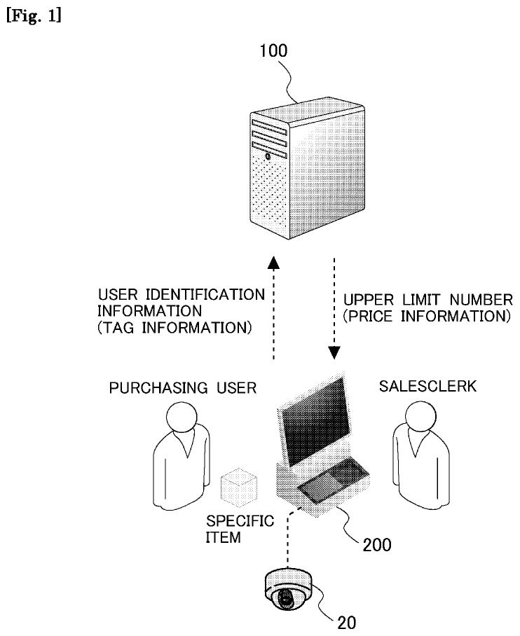

FIG. 1 is a diagram illustrating the general configuration of the sales management system according to the embodiment. The sales management system according to the embodiment includes a server apparatus 100 and a store terminal 200. The server apparatus 100 is an information processing apparatus for controlling the number of items sold in a store under the management of the sales management system. The store terminal 200 is installed in the store under the management of the sales management system and used to perform the checkout process (the process of receiving payment for items sold in the store etc.).

In the sales management system, a user who wishes to purchase an item addresses an operator of the store terminal 200 (i.e. a salesclerk) to proceed with the process of checking out the item. The salesclerk thus addressed causes the store terminal 200 to read information of a tag attached to the item (e.g. identification information of the item). Then, the store terminal 200 sends information read from the tag (which will also be referred to as “tag information” hereinafter) to the server apparatus 100. The server apparatus 100 retrieves price information linked with the tag information and sends the price information retrieved to the store terminal 200. The store terminal 200 receives the price information and performs the item checkout process (namely, the process of receiving payment for the item) on the basis of the price information. After the completion of the item checkout process, the store terminal 200 creates sales information about the number of sold items and sends the sales information to the server apparatus 100. The server apparatus 100 receives the sales information and performs stock management based on the number of sold items. For example, if the number of sold items is one, the recorded number of items in stock is decreased by one.

When the item that the user wishes to purchase is a specific item (namely, an item for which an upper limit of the number of items allowed to be purchased is to be set), the sales management system according to the embodiment performs the process of limiting the number of items that the user is allowed to purchase. For example, when the server apparatus 100 receives the tag information of the item to be purchased from the store terminal 200, the server apparatus determines whether the item is a specific item. If the item is a specific item, the server apparatus 100 determines a number (or upper limit number) of specific items that the user who wishes to purchase this item (who will also be referred to as “purchasing user” hereinafter) is allowed to purchase on the basis of the identification information of this user. The upper limit number set in this embodiment is the number of specific items that the purchasing user is allowed to purchase through the present item checkout process. The information about the upper limit number determined by the server apparatus 100 is sent from the server apparatus 100 to the store terminal 200 with the aforementioned price information. Then, the store terminal 200 performs the processing of informing the salesclerk of the information about the upper limit number received from the server apparatus 100. For example, the store terminal 200 executes the processing of displaying the upper limit number on a display device that the store terminal 200 has. In consequence, the salesclerk can judge whether the number of specific items that the purchasing user wishes to purchase exceeds the upper limit number. If the number of specific items that the purchasing user wishes to purchase exceeds the upper limit number, the salesclerk can ask the purchasing user to reduce the number of specific items to be purchased to or below the upper limit number.

The sales management system of this embodiment uses image information obtained by capturing an image of the purchasing user as user identification information. This image information is obtained by capturing the image by a camera 20 with which the store terminal 200 is equipped, triggered by its reading the tag information of the item. The image information obtained by the camera 20 is linked with the tag information and sent from the store terminal 200 to the server apparatus 100. The process of capturing an image of the purchasing user by the camera 20 and the process of sending the obtained image information to the server apparatus 100 may be carried out on condition that the tag information read by the store terminal 200 matches the tag information of a specific item. In this connection, the tag information of the specific item may be stored in the store terminal 200 in advance.

(System Configuration)

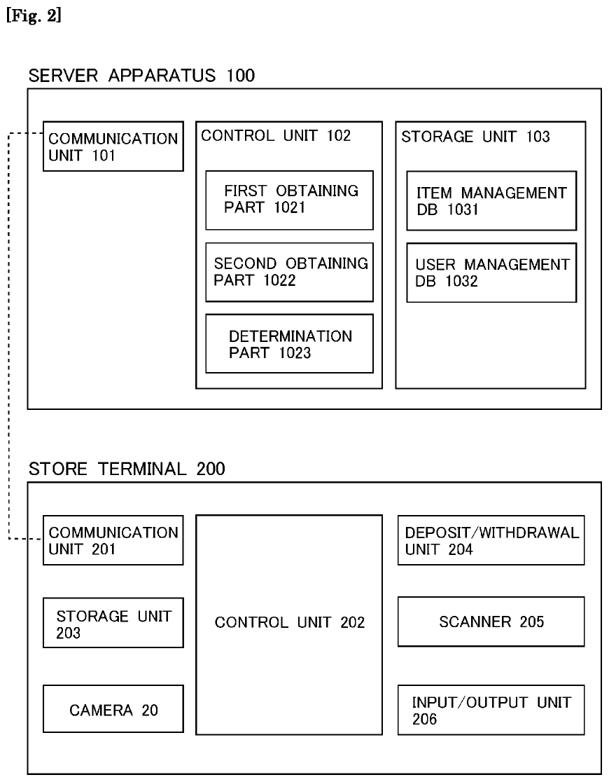

The configuration of the sales management system will be described with reference to FIG. 2. FIG. 2 is a block diagram illustrating exemplary configurations of the server apparatus 100 and the store terminal 200 illustrated in FIG. 1.

(Server Apparatus 100)

The server apparatus 100 is an information processing apparatus for controlling the number of items sold in the store under the management of the sales management system. When an item that a purchasing user wishes to purchase is a specific item, the server apparatus 100 in the system according to the embodiment determines the aforementioned upper limit number on the basis of the user identification information of the purchasing user. The server apparatus 100 also has the function of supplying price information of the item to the store terminal 200.

The server apparatus 100 may be constituted by a general-purpose computer. For example, the server apparatus 100 includes a processor, such as a CPU or a GPU, a main storage unit, such as a RAM or ROM, and an auxiliary storage unit, such as an EPROM, a hard disk drive, or a removable medium. The removable medium may be a recording medium, such as a USB memory, a CD, or a DVD. The auxiliary storage unit stores an operating system (OS), programs, and tables. The processor executes a program(s) stored in the auxiliary storage unit to implement functions for achieving desired purposes that will be described later. Some or all the functions of the server apparatus 100 may be implemented by a hardware circuit(s), such as an ASIC or an FPGA.

As illustrated in FIG. 2, the server apparatus 100 according to the embodiment includes a communication unit 101, a control unit 102, and a storage unit 103.

The communication unit 101 connects the server apparatus 100 to a network. For example, the communication unit 101 communicates with the store terminal 200 via the network using a communication network, such as LAN (Local Area Network), WAN (Wide Area Network), or Wi-Fi (registered trademark). The communication unit 101 may be connected to the network using a mobile communication service, such as 5G (5th Generation) mobile communications or LTE (Long Term Evolution) mobile communications.

The control unit 102 is constituted by a processor, such as a CPU, and performs overall control of the server apparatus 100. The control unit 102 in the system of this embodiment has, as functional modules, a first obtaining part 1021, a second obtaining part 1022, and a determination part 1023. The control unit 102 implements these functional modules by executing programs stored in the storage unit 103 by the processor.

The first obtaining part 1021 obtains user identification information of the purchasing user. Specifically, when the communication unit 101 receives information (which will be referred to as “purchase request” hereinafter) that contains the aforementioned tag information and the user identification information from the store terminal 200, the communication unit 101 passes the purchase request to the first obtaining part 1021. Thus, the first obtaining part 1021 obtains the user identification information of the purchasing user with the tag information of the item to be purchased. The user identification information obtained by the first obtaining part 1021 is passed to the second obtaining part 1022 together with the tag information.

The second obtaining part 1022 obtains property information of the purchasing user. Specifically, the second obtaining part 1022 firstly determines whether the item identified by the tag information (i.e. the item to be purchased) is a specific item. This determination is made based on data stored in an item management database 1031, which will be described later. If the item to be purchased is a specific item, the second obtaining part 1022 obtains price information of the item to be purchased and property information of the purchasing user. The price information of the item to be purchased is retrieved from the item management database 1031. The property information of the purchasing user is information about the record of the number of specific items that the purchasing user has purchased (or the first information). The property information is retrieved from a user management database 1032, which will be described later. The price information and the first information obtained by the second obtaining part 1022 are passed to the determination part 1023. If the item to be purchased is not a specific item, only the price information of the item is passed to the determination part 1023.

The determination part 1023 determines an upper limit number for the purchasing user. Specifically, when the determination part 1023 receives the price information and the first information from the second obtaining part 1022, the determination part 1023 determines an upper limit number for the purchasing user on the basis of the first information and the limited number of the specific item. The aforementioned limited number is the total number of specific items that each user is allowed to purchase. Therefore, the upper limit number for the purchasing user determined here is the number equal to the limited number minus the number indicated by the first information (namely, the number of specific items that the purchasing user has already purchased). Information about the upper limit number determined by the determination part 1023 is passed to the communication unit 101 together with the price information and sent from the communication unit 101 to the store terminal 200. In the case where the information passed from the second obtaining part 1022 to the determination part 1023 includes only the price information (that is, in the case where the item to be purchased is not a specific item), only the price information is sent to the store terminal 200 through the communication unit 101.

The storage unit 103 stores various information. The storage unit 103 is a recording medium, such as a RAM, a magnetic disk, or a flash memory. What is stored in the storage unit 103 includes various programs executed by the control unit 102 and various data. In the system of this embodiment, the item management database 1031 and the user management database 1032 are formed in the storage unit 103. The item management database 1031 and the user management database 1032 are constructed by managing data stored in the auxiliary storage unit by a database management system program (DBMS program) executed by the processor. The item management database 1031 and the user management database 1032 are, for example, relational databases.

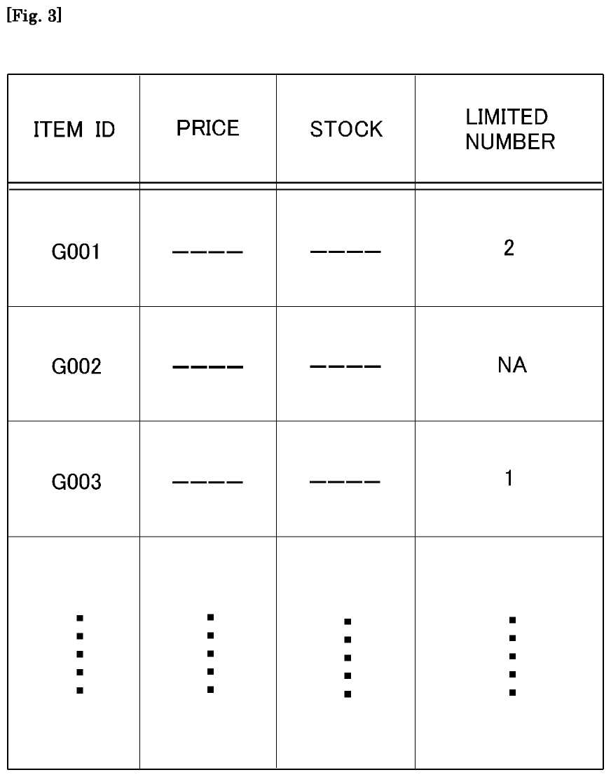

The item management database 1031 stores information about items sold in the store. An example of information stored in the item management database 1031 will now be described with reference to FIG. 3. FIG. 3 illustrates a table structure of information stored in the item management database 1031. As illustrated in FIG. 3, the table stored in the item management database 1031 has the fields of item ID, price, stock, and limited number. This table will also be referred to as the “item information table” hereinafter. What is stored in the item ID field is information for identifying each item (item ID). In this embodiment, tag information of each item is stored in the item ID field as the item ID. What is stored in the price field is information specifying the price of each item (price information). What is stored in the stock field is information specifying the number of each kind of items in stock in the store. The information stored in the stock field is updated every time items arrive in stock and every time items are sold in the store. What is stored in the limited number field is information about the limited number of each kind of items. In the case of the items with no limitation in the number of items that each user is allowed to purchase in total (i.e. the items that are not specific items), “NA” is stored in the limited number field.

The aforementioned limited number may be either a fixed value determined in advance or a variable value varied depending on the number of specific items in stock. For example, the limited number may be set smaller when the number of specific items in stock (i.e. the number specified in the stock field) is small than when it is large. In this case, the upper limit number is determined by the determination part 1023 on the basis of the number indicated by the first information and the number of items in stock. Specifically, the upper limit number is set smaller when the number indicated by the first information is large and the number of items in stock is small than when the number indicated by the first information is small and the number of items in stock is large.

The limited number may be varied depending on the demand for the specific item. For example, the limited number may be set smaller when the demand for the specific item is high than when it is low. In this case, the upper limit number is determined by the determination part 1023 on the basis of the number indicated by the first information and the demand. Specifically, the upper limit number is set smaller when the number indicated by the first information is large and the demand for the item is high than when the number indicated by the first information is small and the demand for the item is low. The demand for each specific item may be forecast by the server apparatus 100 or using external service. The method of forecasting the demand is not limited to a specific method but any known method may be employed. For example, the demand may be forecast on the basis of sales of the specific item in the store or sales of the specific item in the market. Alternatively, the demand may be forecast on the basis of the number of users who have made advance order of the specific item in the store. Still alternatively, the demand may be forecast on the basis of the topicality of the specific item on the Internet.

The limited number may be varied depending on both the number of specific items in stock and the demand. For example, the limited number may be set smaller when the demand for the specific item is high and the number in stock is small than when the demand is low and the number in stock is large. In this case, the upper limit number is determined by the determination unit 1023 on the basis of the number indicated by the first information, the number of items in stock, and the demand. Specifically, the larger the number indicated by the first information is, the smaller the number of items in stock is, and the higher the demand is, the smaller the upper limit number is set.

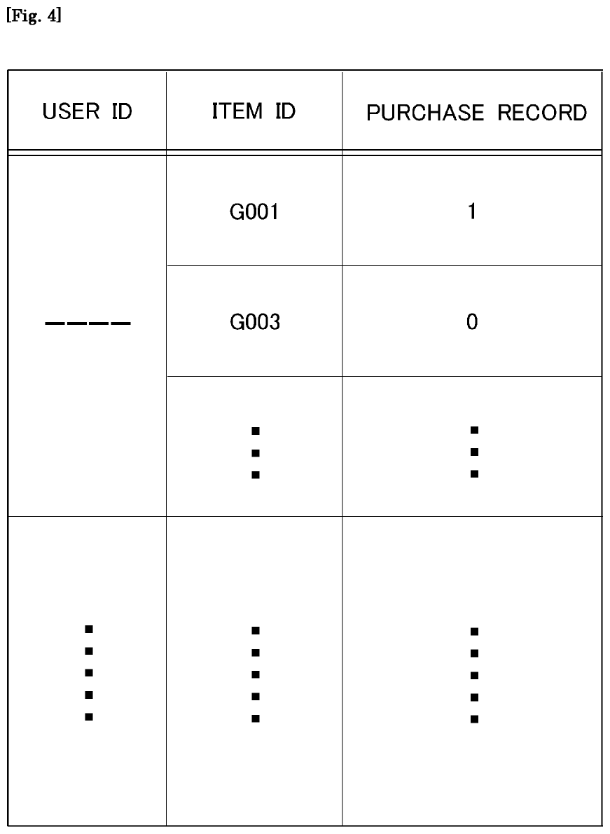

What is stored in the user management database 1032 is information about users who have records of purchase in the store under the management of the sales management system. An example of information stored in the user management database 1032 will be described with reference to FIG. 4. FIG. 4 illustrates a table structure of information stored in the user management database 1032. As illustrated in FIG. 4, the table stored in the user management database 1032 has the fields of user ID, item ID, and purchase record. This table will also be referred to as the “user information table” hereinafter. What is stored in the user ID field is information for identifying each user (user ID). In the case of this embodiment, an image of the face of each user is stored in the user ID field as the user ID. The user's face image stored in the user ID field is created by extracting an image of the user's face from an image captured by the camera 20 when the user purchased an item in the store in the past. What is stored in the item ID field is the item ID (i.e. tag information) of an item that the user purchased in the store in the past. In the case where a user has purchased a plurality of kinds of items in the store, the item IDs of a plurality of items are linked with the user ID of that user. What is stored in the purchase record field is the number of each kind of items that the user has purchased in the store.

The user management database 1032 may store user information tables only for the users who purchased specific items in the store in the past.

(Store Terminal 200)

The store terminal 200 will be described next. The store terminal 200 is a computer used to perform the item checkout process (e.g. receiving payment for purchased items). The store terminal 200 is installed in the store under the management of the sales management system. Typically, the store terminal 200 is a POS (Point-Of-Sale) terminal or a tablet terminal. As illustrated in FIG. 2, the store terminal 200 has a communication unit 201, a control unit 202, a storage unit 203, a deposit/withdrawal unit 204, a scanner 205, an input/output unit 206, and a camera 20.

The communication unit 201 has a configuration similar to the communication unit 101 of the server apparatus 100 and communicates with the server apparatus 100 via the network.

The control unit 202 is constituted by a microcomputer and performs overall control of the store terminal 200. For example, when the input/output unit 206 (specifically described later) receives an operation for starting the item checkout process, the control unit 202 makes the scanning function of the scanner 205 active. When the scanner 205 reads the tag information of an item, the control unit 202 activates the camera 20 (specifically described later) to cause it to capture an image of the purchasing user. Then, the control unit 202 creates a purchase request containing the tag information and the image information of the purchasing user. The purchase request created by the control unit 202 is sent to the server apparatus 100 through the communication unit 201.

When the communication unit 201 receives information (e.g. price information of the item) that is sent from the server apparatus 100 in response to the purchase request, the control unit 202 causes the input/output unit 206 (specifically described later) to display the price of the item. When, thereafter, a amount of a payment by the purchasing user is deposited into the deposit/withdrawal unit 204 (specifically described later), the control unit 202 calculates the amount of change on the basis of the amount of paid money and the price of the item. Then, the control unit 202 causes the deposit/withdrawal unit 204 to output the calculated amount of change. In the case where the information sent from the server apparatus 100 in response to the purchase request includes information about the aforementioned upper limit number, the control unit 202 causes the input/output unit 206 to display the upper limit number as well as the price of the item.

The storage unit 203 stores various information. The storage unit 203 is a recording medium, such as a RAM, a magnetic disk, or a flash memory. What is stored in the storage unit 203 includes various programs executed by the control unit 202 and various data.

The deposit/withdrawal unit 204 receives the deposit operation performed by the salesclerk or the purchasing user and withdraws a change that is equal in amount to the deposit amount minus the price of the item. The amount of change is calculated by the control unit 202 or, alternatively, the deposit/withdrawal unit 204. The deposit/withdrawal unit 204 may be provided with a deposit/withdrawal part for coins and a deposit/withdrawal part for paper money. The deposit/and withdrawal unit 204 may be provided with a device for reading identification information of electronic money or identification information of credit cards.

The scanner 205 is used to read information of tags attached to items to be purchased. The scanner 205 includes, for example, a barcode reader that reads barcodes printed on tags or a RFID (Radio Frequency Identifier) reader that reads information stored in IC tags.

The input/output unit 206 receives input operations performed by the salesclerk and displays information to the salesclerk. The input/output unit 206 includes, for example, a touch panel, a control circuit for the touch panel, a liquid crystal display, and a circuit for the liquid crystal display. The touch panel and the liquid crystal display may be a single touch panel display. The input/output unit 206 of this embodiment receives an operation for starting the item checkout process. Moreover, the input/output unit 206 displays information read from the tag of the item to be purchased, the price information of the item, and the aforementioned upper limit number.

The camera 20 is used to capture an image of the purchasing user. The camera 20 may be either a dedicated camera used solely to capture images of purchasing users or a surveillance camera that captures images of an area in which the store terminal 200 is installed. In other words, what is essential is that the camera 20 is capable of capturing an image of a distinctive portion of the purchasing user (e.g. the face of the purchasing user). The camera 20 is triggered into operation by the scanner's 205 operation of reading the tag information of the item to capture an image of the purchasing user. The image information of the purchasing user obtained by image capturing by the camera 20 is contained in the aforementioned purchase request together with the tag information read by the scanner 205 and sent to the server apparatus 100 through the communication unit 201.

(Process Performed by Server Apparatus)

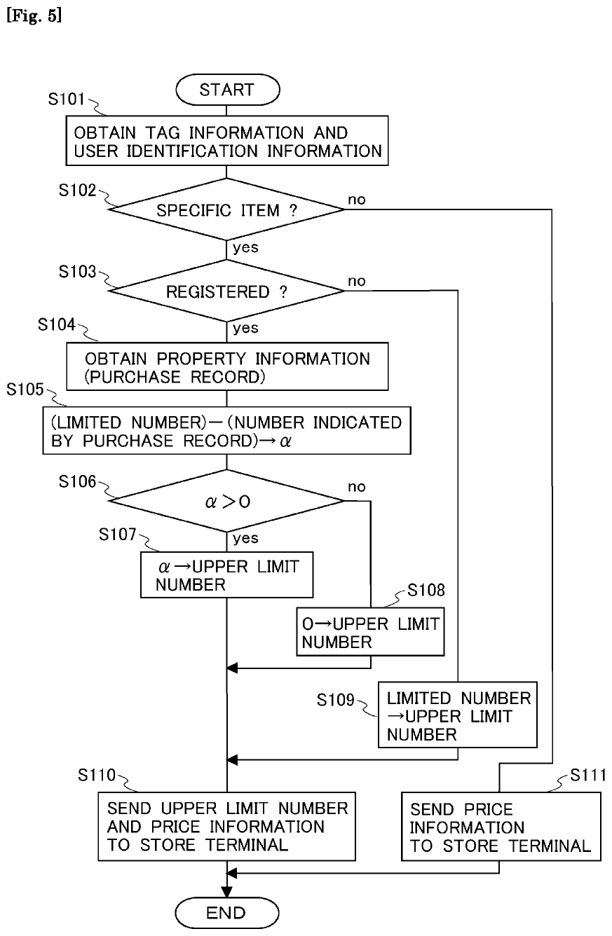

A process performed by the server apparatus 100 of this embodiment will be described with reference to FIG. 5. FIG. 5 is a flow chart of a process executed by the server apparatus 100 when it receives a purchase request sent from the store terminal 200.

When a purchasing user asks a salesclerk to proceed with the process for checking out an item in the store under the management of the sales management system, the salesclerk enters a command for executing the item checkout process to the input/output unit 206 of the store terminal 200. This makes the scanning function of the scanner 205 of the store terminal 200 active. As the salesclerk causes the scanner 205 to read the tag information of the item, the camera 20 is activated to capture an image of the purchasing user. Then, the store terminal 200 creates a purchase request containing the tag information read by the scanner 205 and the image information of the purchasing user obtained by the camera 20 and sends the purchase request to the server apparatus 100 through the communication unit 101. When the communication unit 101 of the server apparatus 100 receives the purchase request, the communication unit 101 passes the purchase request to the first obtaining part 1021. Thus, the first obtaining part 1021 obtains user identification information of the purchasing user with the tag information of the item to be purchased (step S101). The tag information and the user identification information obtained by the first obtaining part 1021 are passed from the first obtaining part 1021 to the second obtaining part 1022.

The second obtaining part 1022 accesses the item management database 1031 on the basis of the tag information to find the item information table corresponding to the item to be purchased. In other words, the second obtaining part 1022 finds the item information table whose item ID field stores the item ID that matches the tag information. The second obtaining part 1022 refers to the limited number field of the item information table thus found to determine whether the item to be purchased is a specific item (step S102). For example, if a figure indicating the limited number is stored in the limited number field, the second obtaining part 1022 determines that the item to be purchased is a specific item (an affirmative answer in step S102). If “NA” is stored in the limited number field, the second obtaining part 1022 determines that the item to be purchased is not a specific item (a negative answer in step S102).

If step S102 is answered in the affirmative, the second obtaining part 1022 accesses the user management database 1032 on the basis of the user identification information to determine whether the purchasing user has already been registered in the user management database 1032 (step S103). In other words, the second obtaining part 1022 determines whether there is a record of past purchase of an item by the purchasing user in the store under the management of the sales management system. If a user information table in which user ID that matches the user identification information is stored in the user ID field is stored in the user management database 1032, step S103 is answered in the affirmative. On the other hand, if a user information table in which user ID that matches the user identification information is stored in the user ID field is not stored in the user management database 1032, step S103 is answered in the negative. The determination as to whether the information stored in the user ID field matches the user identification information or not may be made by a method using a face recognition algorithm. Specifically, the second obtaining part 1022 extracts an image of the face of the purchasing user from the image information as the user identification information. Then, the second obtaining part 1022 compares the extracted face image with the face image stored in the user ID field of each user information table. If there is a match of the images in any user information table among the user information tables stored in the user management database 1032, step S103 is answered in the affirmative. If there is no match in all the user information tables stored in the user management database 1032, step S103 is answered in the negative.

If step S103 is answered in the affirmative, the second obtaining part 1022 obtains property information of the purchasing user (step S104). In this embodiment, the second obtaining part 1022 extracts the information stored in the purchase record field of the user information table in which there is a match in step S103 as the property information of the purchasing user. Moreover, the second obtaining part 1022 extracts the information stored in the price field (i.e. the price information) and the information stored in the limited number field (i.e. the limited number) from the item information table of the item to be purchased. The property information, the price information, and the information about the limited number extracted by the second obtaining part 1022 are passed to determination part 1023.

The determination part 1023 subtracts the number of items recorded in the purchase record from the limited number of the items to be purchased to obtain a calculated value α (step S105). Then, the determination part 1023 determines whether the calculated value α is larger than zero (step S106). If the calculated value α is larger than zero (an affirmative answer in step S106), the determination part 1023 sets the upper limit number equal to the calculated value α (step S107). If the calculated value α is equal to or smaller than zero (a negative answer in step S106), the determination part 1023 sets the upper limit number to zero. (step S108).

If step S103 is answered in the negative, the second obtaining part 1022 passes the information about the limited number of the item to be purchased and the price information to the determination part 1023. In this case, the determination part 1023 sets the upper limit number equal to the limited number. (Step S109).

After the upper limit number is determined in step S107, S108, or S109, the determination part 1023 sends information about the upper limit number thus determined and the price information of the item to be purchased to the store terminal 200 through the communication unit 101 (step S110). Then, the store terminal 200 displays the upper limit number and the price information by the input/output unit 206. Thus, the salesclerk can judge whether the number of items (specific items) that the purchasing user wishes to purchase exceeds the upper limit number. If the number of items that the purchasing user wishes to purchase exceeds the upper limit number, the salesclerk can ask the purchasing user to reduce the number of items or give up the purchase of the item. Thus, it is possible to keep the number of items that the purchasing user can purchase in total to or smaller than the limited number.

In the case where the item to be purchased is not a specific item (a negative answer in step S102), the second obtaining part 1022 passes only the price information of the item to be purchased to the determination part 1023. Then, the determination part 1023 sends only the price information to the store terminal 200 through the communication unit 101 (step S111). Then, the store terminal 200 displays only the price information of the item to be purchased by the input/output unit 206. In consequence, the salesclerk can know that the item that the purchasing user wishes to purchase is not a specific item, namely, and that there is no limitation in the number of items that the purchasing user is allowed to purchase.

The processing routine according to the flow chart of FIG. 5 enables more accurate control of the number of items that each user is allowed to purchase. In consequence, when selling items that are limited in number that each user is allowed to purchase in total (e.g. items sold at special prices or scarce items), it is possible to prevent each user from purchasing a larger number of items than a limited number with improved reliability. Even in the case where a user comes to a place of checkout more than once or enters the store more than once, it is possible to keep the number of items that the user can purchase to or smaller than the limited number. In consequence, it is possible to prevent each user from purchasing an unduly large number of items.

### <First Modification>

While a case where the record of purchase of the specific item is used as property information of the purchasing user has been described in the above description of the embodiment, the property information may include information about the composition of the purchasing user's family as second information in addition to the record of purchase of the specific item. The second information used in this modification is information about the number of purchasing user's family members including the purchasing user.

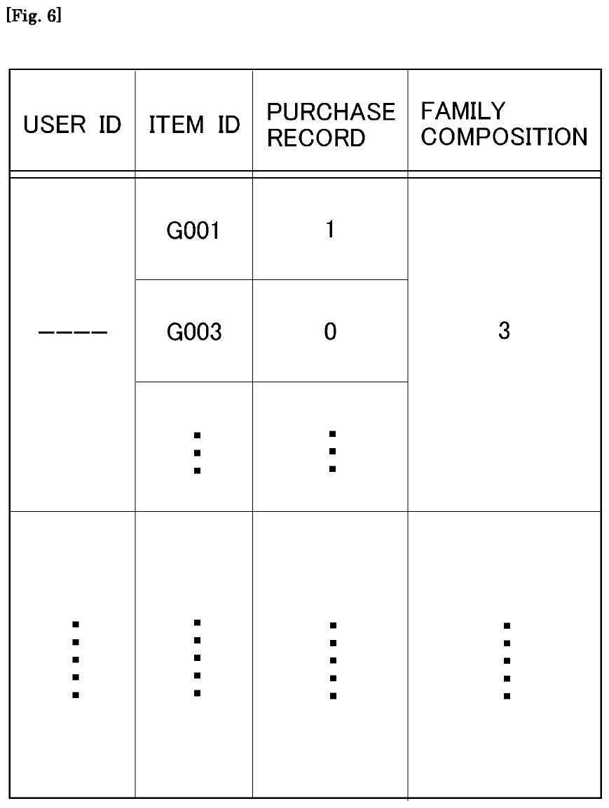

FIG. 6 illustrates an exemplary structure of the user information table according to the first modification. The user information table illustrated in FIG. 6 has the field of family composition in addition to the fields of user ID, item ID, and purchase record. What is stored in the family composition field is information about the number of family members including the user. For example, the number of family members who live in the same house as the user is three, the figure “3” is stored in the family composition field. The information about the number of members of the user's family may be informed to the store when the user signs up for the store (e.g. for a point card service of the store). Alternatively, the information about the number of members of the user's family may be supplied to the store by the credit card company of a credit card used by the user.

(Process Performed by Server Apparatus 100)

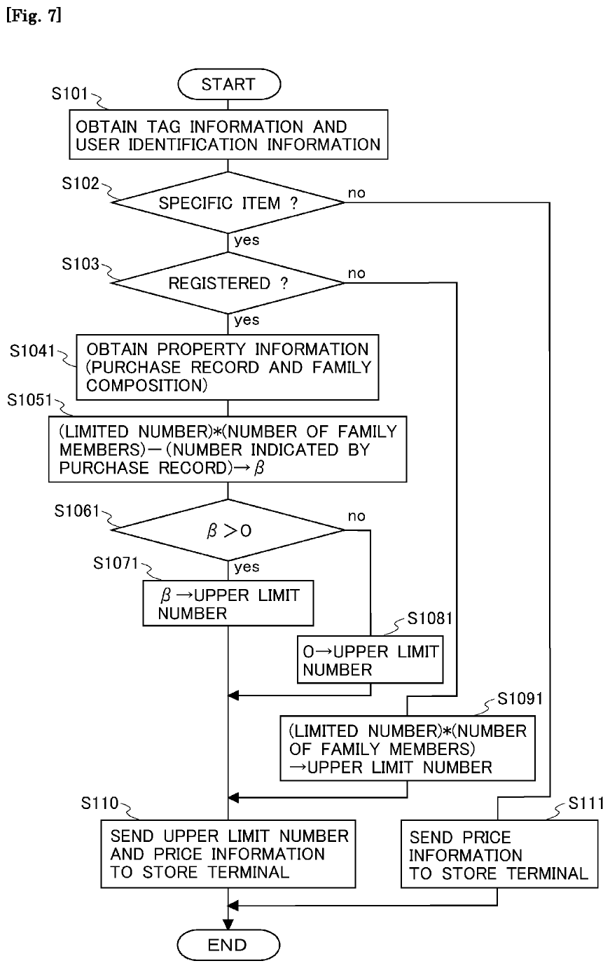

A process performed by the server apparatus 100 according to this modification will be described with reference to FIG. 7. FIG. 7 is a flow chart of a process executed by the server apparatus 100 when it receives a purchase request sent from the store terminal 200. In FIG. 7, the processing steps same as those in the process according to the flow chart of FIG. 5 are denoted by the same reference signs.

In the process according to the flow chart of FIG. 7, the processing of step S104 in FIG. 5 is replaced by the processing of step S1041. In step S1041, the second obtaining part 1022 extracts the information stored in the purchase record field and the information stored in the family composition field from the user information table of the purchasing user as the property information of the purchasing user. The property information thus extracted is passed to the determination part 1023 together with the price information of the item to be purchased.

Then, the determination part 1023 executes the processing of steps S1051 to S1081 instead of the processing of steps S105 to S108 in the process according to the flow chart of FIG. 5. In step S1051, the determination part 1023 calculates a calculated value β by the following equation 1.

β=(limited number)×(number of family members)−(number indicated by purchase record) equation 1

In step S1061, the determination part 1023 determines whether the calculated value β calculated in step S1051 is larger than zero. If the calculated value β is larger than zero (an affirmative answer in step S1061), the determination part 1023 sets the upper limit number to the calculated value β (step S1071). On the other hand, if the calculated value β is equal to or smaller than zero (a negative answer in step S1061), the determination part 1023 sets the upper limit number to zero (step S1081).

In the case where step S103 is answered in the negative, the processing of step S1091 is executed instead of the processing of step S109 in the process according to the flow chart of FIG. 5. Specifically, if step S103 is answered in the negative, the second obtaining part 1022 passes the information about the composition of the purchasing user's family to the determination part 1023 in addition of the information about the limited number of the item to be purchased and the price information thereof. Then, the determination part 1023 sets the upper limit number to the number equal to the product of the limited number and the number of purchasing user's family members (step S1091).

This modification allows the total number of specific items that each user is allowed to purchase to be varied depending on the composition of the user's family.

The property information of the purchasing user may include only information about the composition of his/her family. In that case, the upper limit number for the purchasing user may be set to the number equal to the product of the limited number and the number of user's family members.

### <Second Modification>

While a case where the record of purchase of the specific item is used as property information of the purchasing user has been described in the above description of the embodiment, the property information may include information about a record of an instance of resale conducted by the purchasing user as third information in addition to the record of purchase of the specific item. The third information used in this modification is information indicating whether there is a record of an instance of resale of an item that the purchasing user purchased in the past on an electronic commerce (EC) site conducted by the purchasing user.

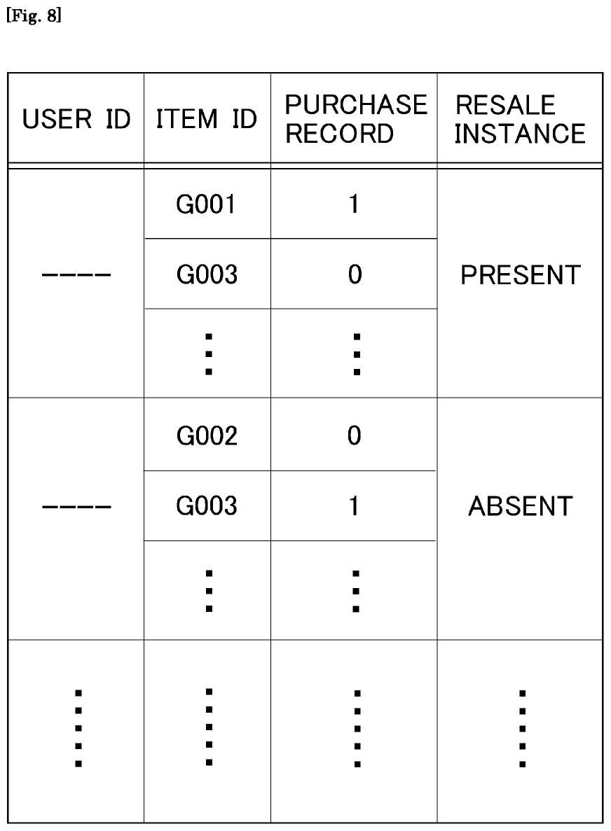

FIG. 8 illustrates an exemplary structure of the user information table according to the second modification. The user information table illustrated in FIG. 8 has the field of resale instance in addition to the fields of user ID, item ID, and purchase record. What is stored in the resale instance field is information indicating whether there is a record of an instance of resale conducted by the user. If there is a record of an instance of resale conducted by the user, “present” is stored in the resale instance field. On the other hand, if there is no instance of resale conducted by the user, “absent” is stored in the resale instance field. Information about the presence/absence of a record of an instance of resale conducted by the user may be provided by a company that runs or manages an EC site.

The determination part 1023 may set the upper limit number smaller when a record of an instance of resale conducted by the purchasing user is present than when it is absent. For example, if a record of an instance of resale conducted by the purchasing user is present, the upper limit number may be set to zero without regard to the purchase record of the purchasing user. Alternatively, if a record an instance of resale conducted by the purchasing user is present, the determination part 1023 may determine the upper limit number for the purchasing user who has conducted resale by making a downward correction (e.g. the correction of subtracting a certain number) to the upper limit number determined by the process according to the above-described embodiment or the first modification. In the case where a record of an instance of resale conducted by the purchasing user is absent, the upper limit number may be determined in the same manner as the above-described embodiment or the first modification.

The second modification can prevent the purchasing user from purchasing an unduly large number of specific items for the purpose of resale.

### <Third Modification>

While in the above embodiment, image information of the purchasing user is used as user identification information, identification information of electronic money used by the purchasing user, identification information of a credit card, or identification information of a membership card may also be used as user identification information.

### <Others>

The above embodiment and modifications have been described only by way of example. Modifications can be made to them without departing from the essence of this disclosure. For example, the processing performed by the server apparatus 100 may be performed partly or entirely by the store terminal 200 or an information processing apparatus other than the server apparatus 100.

The processes that have been described in this disclosure may be employed in any combination so long as it is technically feasible to do so. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (or information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of the computer-readable, non-transitory storage medium include any type of disc medium including a magnetic disc, such as a floppy disc (registered trademark) and a hard disk drive (HDD), and an optical disc, such as a CD-ROM, a DVD and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus for controlling the number of sold items comprising a controller which includes at least one processor,
the controller being configured to execute the processing of:
obtaining user identification information for identifying a user,
obtaining property information indicating a property of the user on the basis of the user identification information, and
determining an upper limit number on the basis of the property information, the upper limit number being the number of specific items that the user is allowed to purchase.

2. An information processing apparatus according to claim 1, wherein the property information includes first information, and the controller determines the upper limit number on the basis of the first information, the first information being information about a record of the number of specific items that the user has purchased.

3. An information processing apparatus according to claim 2, wherein the controller sets the upper limit number smaller when the number of specific items that the user has purchased is large than when it is small.

4. An information processing apparatus according to claim 1, wherein the property information includes second information, and the controller determines the upper limit number on the basis of the second information, the second information being information about the composition of the user's family.

5. An information processing apparatus according to claim 4, wherein the controller sets the upper limit number larger when the number of members of the user's family is large than when it is small.

6. An information processing apparatus according to claim 1, wherein the property information includes third information, and the controller determines the upper limit number on the basis of the third information, the third information being information about a record of an instance of resale conducted by the user.

7. An information processing apparatus according to claim 6, wherein the controller sets the upper limit number smaller when a record of an instance of resale conducted by the user is present than when it is absent.

8. An information processing apparatus according to claim 1, wherein the controller determines the upper limit number on the basis of the property information and stock information, the stock information being information about the specific items in stock.

9. An information processing apparatus according to claim 1, wherein the controller determines the upper limit number on the basis of the property information and demand information, the demand information being information about the demand for the specific item.

10. An information processing apparatus according to claim 1, wherein the user identification information includes image information whose subject is the user.

11. An information processing apparatus according to claim 1, wherein the controller is configured to further execute the processing for informing a person in charge of sales of the specific item of the upper limit number.

12. An information processing method for controlling the number of sold items comprising the following steps of processing executed by a computer:
obtaining user identification information for identifying a user,
obtaining property information indicating a property of the user on the basis of the user identification information, and
determining an upper limit number on the basis of the property information, the upper limit number being the number of specific items that the user is allowed to purchase.

13. An information processing method according to claim 12, wherein the property information includes first information, and in the step of determining the upper limit number, the upper limit number is determined on the basis of the first information, the first information being information about a record of the number of specific items that the user has purchased.

14. An information processing method according to claim 12, wherein the property information includes second information, and in the step of determining the upper limit number, the upper limit number is determined on the basis of the second information, the second information being information about the composition of the user's family.

15. An information processing method according to claim 12, wherein the property information includes third information, and in the step of determining the upper limit number, the upper limit number is determined on the basis of the third information, the third information being information about a record of an instance of resale conducted by the user.

16. An information processing method according to claim 12, wherein in the step of determining the upper limit number, the upper limit number is determined on the basis of the property information and stock information, the stock information being information about the specific items in stock.

17. An information processing method according to claim 12, wherein in the step of determining the upper limit number, the upper limit number is determined on the basis of the property information and demand information, the demand information being information about the demand for the specific item.

18. An information processing method according to claim 12, wherein the user identification information includes image information whose subject is the user.

19. An information processing method according to claim 12, further comprising the step of informing a person in charge of sales of the specific item of the upper limit number.

20. A non-transitory storage medium storing an information processing program,
the information processing program being configured to cause a computer to execute the following steps of:
obtaining user identification information for identifying a user,
obtaining property information indicating a property of the user on the basis of the user identification information, and
determining an upper limit number on the basis of the property information, the upper limit number being the number of specific items that the user is allowed to purchase.
